(19) United States
(12) Patent Application Publication
(10) Pub. No.: US 2024/0170167 A1
(43) Pub. Date: May 23, 2024

(54) NUCLEAR REACTOR WITH A HEAVY LIQUID METAL COOLANT

(71) Applicant: "AKME-ENGINEERING", JOINT-STOCK COMPANY, Moscow (RU)

(72) Inventors: Aleksandr Vladislavovich DEDYL, Moscow (RU); Vladimir Sergeevich STEPANOV, Podol'sk (RU); Georgii Il'ich TOSHINSKII, Moscow (RU); Urii Aleksandrovich ARSEN'EV, Podol'sk (RU); Oleg Gennad'evich KOMLEV, Moscow (RU); Mihail Petrovich VAHRUSHIN, Podol'sk (RU); Sergey Aleksandrovich GRIGOR'EV, Moscow (RU); Sergey Vladimirovich SAMKOTRYASOV, Podol'sk (RU)

(73) Assignee: "AKME-ENGINEERING", JOINT-STOCK COMPANY, Moscow (RU)

(21) Appl. No.: 18/281,954

(22) PCT Filed: Oct. 4, 2021
(86) PCT No.: PCT/RU2021/000425

§ 371 Date: Sep. 13, 2023

(30) Foreign Application Priority Data
Mar. 15, 2021 (RU) 2021106582

(51) Int. Cl. G21C 15/247; G21C 15/18; G21C 15/28

(52) U.S. Cl. CPC G21C 15/247; G21C 15/182; G21C 15/28

(57) ABSTRACT

The invention relates to nuclear power engineering and is intended for using in power plants with a reactor with a heavy liquid metal coolant (HLMC) based on lead or on lead-bismuth alloys.

The invention makes it possible to increase the radiation protection efficiency for the in-vessel equipment of a nuclear reactor, to increase the heat storage capacity of the primary circuit, to reduce the nuclear reactor weight, and to improve its strength characteristics.

In the in-vessel space of a nuclear reactor, which is not occupied by the necessary equipment, containers filled with a material that reflects or absorbs neutrons, with a heat capacity greater than that of the coolant, are installed with gaps ensuring the coolant flow, while the containers are placed in such a way that the resulting gaps form channels with a turbulent coolant flow to cool these containers at a flow rate corresponding to the nominal power output level of the nuclear reactor.

### FIELD OF THE INVENTION

The invention relates to nuclear power engineering and is intended for using in power plants with a reactor with a heavy liquid metal coolant (HLMC) based on lead or on lead-bismuth alloys.

### PRIOR ART

There are known HLMC reactors where the core is immersed in a tank filled with a coolant (for example, U.S. Pat. No. 8,817,942, BREST-OD-300 project, Russian patent 2247435, Russian patent 2545098, Russian patent 2313143, PCT application WO 2016/147139).

U.S. Pat. No. 8,817,942 discloses a nuclear reactor cooled with liquid metal (for example, a heavy metal such as lead or a lead-bismuth alloy), or sodium, or molten salts, with a core formed by fuel elements immersed in a fluid circulating between the core and at least one heat exchanger.

The BREST-OD-300 reactor (“Structural and layout solutions of the main units and equipment of the BREST-OD-300 reactor. V. N. Leonov, A. A. Pikapov, A. G. Sila-Novitsky et al. VANT, series: Ensuring the NPP Safety, issue 4, Moscow, SUE NIKIET, 2004, pp. 65-72) includes a reinforced concrete pit with an internal steel lining, a reactor vessel unit with a top cover, a core, a system of actuators for influencing the core reactivity, units of steam generators and main circulation pumps, a system of mass exchangers and filters for the coolant cleaning, a system for reloading the core elements, a system for monitoring process parameters, and other auxiliary systems. The vessel unit of the BREST-OD-300 reactor is made in the form of a central and four peripheral cylindrical pits with flat bottoms, which, together with the upper cover, form the boundary of the primary circuit of the reactor unit, in which the coolant circulates, providing heat removal from the core, and a protective gas volume is formed, as well as in-core devices and equipment are installed. The core is located in the central pit of the vessel unit, and the steam generator units are located in four peripheral pits connected to the central pit with upper and lower connecting pipes. Each steam generator is made in the form of a tubular heat exchanger for heating water (steam) with supercritical parameters, which is immersed in the lead coolant flow moving in the annular space of the steam generator body from top to bottom. The lead coolant in the BREST-OD-300 reactor is circulated by pumping it by the circulation pumps from the steam generator pit to the reactor pressure chamber level, from which the coolant is lowered to the core inlet chamber, rises and heats up in the core in contact with the fuel elements (FEs) of the fuel assemblies, and then enters the common chamber with the “hot” coolant. Then, the coolant flows into the inlet chambers and the annular space of the steam generators, is cooled, and enters the inlet of the circulation pumps, and then it is again fed into the reactor pressure chamber.

The core is surrounded by rows of lateral lead reflector blocks made in the form of dense steel shells filled with a flowing lead coolant. A part of the reflector adjacent to the zone of the blocks is made in the form of vertical channels, closed from above (using a gas bell) and open for filling with lead from below, while its level in the channel corresponds to the lead coolant pressure at the core inlet. Using these channels with variable height levels of lead pillars that affect the neutron leakage, the reactivity and power of the reactor are passively linked to the coolant flow rate through the core, which is an important factor to control the power output through the coolant flow rate and no less than an important safety factor.

Russian patent 2247435 discloses an integral circuit layout of the main equipment, in which the unit includes a reactor installed in the central tank, steam generators and circulation pumps located in the peripheral tanks, as well as a system for the coolant purification with gas mixtures to reduce lead oxides. The reactor, steam generators, and circulation pumps are located under the free level of the liquid metal coolant. The steam generators of the unit are made in the form of tubular heat exchangers, in which water (steam) is fed in the pipes, and a lead coolant circulates from top to bottom in an annular space. In the reactor unit, a common gas cavity is made between the free level of the liquid metal coolant and the upper cover, which communicates with the gas circulation and treatment system.

The integral circuit layout of the main equipment is characterized by a high specific volume of lead coolant per reactor power output unit, which leads to an increase in the reactor size and the capital expenditures for the reactor creation.

In all these cases, a significant problem is the large coolant weight, high loads on the supporting structures of the reactor vessel, and difficulties in ensuring the equipment resistance to seismic effects due to its large weight and dimensions.

Russian patent 2545098 solves the problem of reducing the coolant weight by placing equipment with high internal pressure (steam generator) outside the active medium (lead coolant).

The reactor unit, disclosed in Russian patent 2545098, includes a reactor pit with an upper cover, a reactor with a core located in the pit, steam generators, circulation pumps, circulation pipelines, and systems of actuators and devices for ensuring the start-up, operation, and shutdown of the reactor unit. The steam generators are located in separate boxes and communicate with the reactor pit using circulation pipelines for lifting and draining the lead coolant; the steam generators and most of the circulation pipelines are located above the lead coolant level in the reactor pit; the circulation pumps are located in the reactor pit on the circulation pipelines for lifting the “hot” lead coolant; and there is a technical means for ensuring the natural circulation of the lead coolant through the reactor core when the circulation pumps are turned off.

However, in the known technical solution, the coolant volume in the circuit is also sufficiently large due to the extended and voluminous circulation channels, which worsens the weight, size, and economic indicators of the unit.

This problem is solved in a nuclear reactor, in particular, in a compact nuclear reactor with liquid metal cooling (WO 2016/147139), including the main reactor vessel, covered with a lid and including a core and a hydraulic separation structure, essentially in a shape of an amphora, limiting the hot header and cold header, in which the coolant circulates that cools the core. Heat exchangers are located between the upper section of the separation structure and the reactor vessel. In this technical solution, the pumps and the steam generator are located closer to the core and require radiation protection, while the neutron protection function is performed by the liquid metal located between the separating structure and the outer ring of the fuel elements.

The disadvantages of the described nuclear reactor include the two most significant problems:
No radiation protection of equipment that requires routine maintenance and maintenance with the participation of personnel during the operation;
Large free coolant volumes in the area opposite the core and in the lower part of the reactor, in which the flow rates are extremely low, an unstable vortex flow may form at reduced power modes or when the reactor is cooled down in the natural convection mode.

Restrictions by the permissible activation of the equipment by with a neutron flux from the core are ensured by removing the pumps, the steam generator, the reactor vessel walls, and the reactor lid from the core.

A reactor vessel thermal protection device is known (Russian patent 2331939). including a core basket, annular steel shells installed and fixed in the said basket, and a separation shell attached to the vessel bottom. The heat shield includes boron carbide blocks. They are installed behind the separation shell and form a layered annular screen along the entire height of the core. Gaps between the boron carbide blocks of one layer are filled with boron carbide blocks of the next layer. The invention makes it possible to exclude hard capture y-radiation in the heat shield elements and to reduce the radiation effect on the reactor vessel.

The disadvantage of this technical solution is that it solves only one particular problem, namely, it ensures the radiation protection of the reactor vessel opposite the core. At the same time, radiation protection is also required in the direction towards the reactor lid, both to protect the equipment installed on the reactor lid and to protect the steam generator from the radiation.

It is important to note that none of the known technical solutions is a simultaneous comprehensive solution to several important safety problems.

First. The most important problems of ensuring the NR safety are to prevent dangerous consequences of failures associated with the heat removal loss, as well as to minimize the radiation consequences of accidents associated with a damage to the safety barriers. Failures or accidents in the systems for heat removal from a nuclear reactor, even when the emergency protection is triggered and the reactor switches to the backup channels for the removal of residual energy releases, result, as a rule, in a short or sufficiently long increase in the temperature in the core, until an equilibrium is established between the removed capacity of the heat removal systems and the capacity of the residual energy release. At the same time, a significant factor ensuring minimization of the dangerous consequences of such events, namely, the temperature increase rate and the maximum values of the achieved temperatures, is the heat capacity of the systems, equipment, and the primary coolant.

Second. A significant problem for the NR safety is the large coolant weight, which makes it difficult to ensure the equipment resistance to seismic effects.

Reducing the size of the reactor vessel in integral type reactors has a positive effect on the economic characteristics of the project and simplifies the designing of the reactor vessel while improving the seismic resistance of the design. However, this raises the known problem of protecting the primary circuit equipment, which in this case is located closer to the core.

Third. With a compact arrangement of the steam generator and its closer location to the nuclear reactor core, in addition to the more well-known problem of activation of steel structures, the problem of activation of impurities in the steam generator water, including the formation of the ¹⁶N isotope as a result of the reaction, becomes more relevant:

¹⁶O(n,p)¹⁶N,

In this case, ¹⁶N further decomposes into ¹⁶O according to the reaction:

$${}^{16} N \frac{β - , γ}{{T}_{1 / 2} = 7 , 13 c} {}^{16} O ,$$

forming an additional background radiation near the steam pipelines and the turbine.

The radiation impact on the reactor vessel and the equipment installed inside the vessel also results in a change in the material properties (for example, loss of plasticity), which can cause an emergency.

The disadvantage of the known nuclear reactors (NR) is that each of the above problems is solved separately using technical means aimed at solving a specific problem.

### DISCLOSURE OF THE INVENTION

Technical measures to ensure the reactor safety in emergencies and during the operation include:
Increase in the heat capacity of the primary circuit elements, which accumulate the generated heat in emergency and transient processes without a noticeable increase in temperature;
Reduction of the reactor weight, which reduces the loads on the load-bearing elements of the reactor during seismic impacts;
Provision of radiation protection of the reactor vessel and equipment, both inside it (steam generator, pump) and outside it (equipment on the reactor lid, equipment in the reactor pit).

The problem solved by the invention is to create an optimal design of a nuclear reactor, by implementing these technical measures, through using a structural element in the primary circuit, which performs simultaneously the function of a heat accumulator and a radiation absorber (neutrons, gamma radiation) while its density is lower than that of the coolant.

The technical result consists in increasing the efficiency of the radiation protection of the in-vessel NR equipment, increasing the heat storage capacity of the primary circuit (the joint heat capacity of the primary circuit coolant and the equipment washed by this coolant), reducing the NR weight, and improving the strength characteristics.

The use of the proposed technical solution makes it possible to form a coolant path without using connecting pipelines.

The said problem is solved and the specified technical result is achieved in such a way that in a nuclear reactor with a heavy liquid metal coolant (HLMC), with, located in the same vessel, at least one heat exchanger or at least one steam generator, control and monitoring elements, one circulation pump of the primary circuit, main channels and auxiliary channels that do not perform the function of core cooling, for the coolant flow, including a header for collecting and distributing the coolant through the main and auxiliary channels, in the in-vessel space of the nuclear reactor, not occupied by these elements, steel containers are placed with gaps, providing the coolant flow, wherein the said containers are filled with materials that primarily reflect or absorb neutrons, with a heat capacity greater than that of the coolant, wherein the said containers are placed in such a way that the resulting gaps form channels with a turbulent coolant flow for cooling these containers at a flow rate corresponding to the nominal power level of the nuclear reactor.

A significant increase in speed above the turbulence limit is undesirable, since it results in an increase in the hydraulic resistance. A significant decrease in the size of the gaps with the transition to a laminar flow is also undesirable, since it impairs the heat transfer between the coolant and the containers and worsens the coolant mixing, which ensures the equalization of temperatures and concentrations of impurities in the coolant in the entire volume.

The latter technical result (equalization of the concentrations of impurities in the coolant) is essential for HLMC reactors, which use the technology for maintaining the optimal oxygen concentration in the coolant to ensure the corrosion resistance of materials.

The critical value of the Reynolds criterion can be taken as the limiting criterion for the transition to the turbulent flow Re:

$$Re = \frac{W \cdot {d}_{Γ}}{v} > {Re}_{κ p} ≅ 2300 ,$$

where:
W is the coolant velocity;
dᵣ is the hydraulic diameter;
v is the kinematic viscosity of the coolant;
Re_{κp} is the critical value of the Reynolds criterion,
and the hydraulic diameter is determined according to the general rule:

$${d}_{Γ} = \frac{4 \cdot S}{P} ,$$

where:
S is the total transverse area of all gaps for the coolant flow between the containers in the section with minimum velocities;
P is the total perimeter of all surfaces wetted with a coolant in the same section.

The containers inside the vessel are installed in such a way that the coolant flow channels are located primarily vertically, which ensures the absence of large-scale vortices in the natural convection conditions and its accelerated development when the pumps are stopped.

Blocks of hot-pressed or vibro-compacted boron carbide powder, or a material based on zirconium hydride, yttrium hydride, or steel can be used as a container filler.

In the latter case, the containers can be replaced with solid steel blocks.

When using boron carbide as a filler, it can be in the form of hot-pressed blocks in one part of the containers, and in the other part it is in the form of a vibro-compacted powder.

Different containers can include different fillers at the same time; for example, a zirconium hydride-based material or steel can be used as a filler in some containers.

There is a free volume inside the containers that is not filled with the filler. The free volume in the container cavity is preferably additionally filled with HLMC, which improves the heat transfer.

The free volume in the containers can preferably be in communication with the coolant volume through specially arranged plugs, with a filter inside them preferably made of a metal wire, preventing the ingress of, for example, boron carbide into the primary circuit and, at the same time, releasing helium formed as a result of capturing the ¹⁰B neutrons.

The containers with the filler are placed in the reactor vessel in such a way as to fill the entire in-vessel space, except for the lowering channel of the pumps, heat exchangers (steam generators), and specially arranged headers, for example, above and below the core or in front of the pump inlet, and to be of the maximum possible size, since this reduces parasitic streaming of neutrons in the gaps between the containers.

The entire coolant circulation circuit is implemented exclusively based on hydraulic connections, due to the formation of the coolant path by placing containers in a certain way inside the reactor vessel and elements of the load-bearing structure of the vessel, in which the containers are fixed against movements.

The containers are limited in size and are installed with gaps, which are necessary to ensure the coolant flow. The average temperature in the containers is determined by the efficiency of removing the heat generated as a result of nuclear reactions of interaction with neutrons and partially gamma rays, due to convective heat transfer to the coolant and the thermal conductivity of the filler.

The containers, together with the elements for their fastening in the reactor vessel, form a load-bearing structure that improves the strength characteristics of the vessel and its resistance to external influences.

Increasing the heat capacity of the equipment located inside the vessel by replacing the excess coolant with elements with a heat capacity greater than that of the coolant makes it possible, in the event of an accident, to accumulate heat in larger volumes than the volume of the primary circuit coolant displaced by them.

The replacement of HLMC with stainless steel increases the heat capacity of the primary circuit by approximately 3 times; the replacement of HLMC with boron carbide more than doubles the heat capacity of the system. At the same time, boron carbide does not chemically interact with HLMC, and as a result of the interaction of neutrons with carbon and boron, significant amounts of isotopes with a long decay period or high radioactivity are not formed.

Surrounding the steam generator with filler blocks, for example, of boron carbide, results in a decrease in the radioactivity of impurities in the generated steam and an increase in safety due to the neutron absorption by boron.

The specific weight of containers with the filler is less than the specific weight of HLMC, which ensures a decrease in the NR weight due to the replacement of a part of the primary circuit coolant with the said blocks.

### BRIEF DESCRIPTION OF DRAWINGS

FIG. 1 shows a 3D view of the reactor unit in accordance with the proposed technical solution.

FIG. 2 shows a 3D detail of the reactor unit view showing the coolant flow direction in the gaps between the blocks.

FIG. 3 shows vertical section 1-1 of the reactor unit along the pump and steam generator. In FIG. 3, the arrows show the coolant circulation pattern in the integral type reactor, the main feature of which is the placement of the core, a pump that ensures the coolant circulation, and a steam generator or a heat exchanger to remove the heat generated in the core, in the same vessel.

FIG. 4 shows a horizontal section of the reactor between the connecting pipes for supplying the coolant to the steam generator and the core.

FIG. 5 shows a detail of a load-bearing structure with blocks placed in it, made in the form of containers with boron carbide (A), as well as examples of possible solutions for choosing the container design (B-F). FIG. 5B shows a detail of the load-bearing structure with sections (the filler is not shown for clarity) and the movement of the elements (shown by the arrows). FIG. 5C shows the container bottom (the filler is not shown for clarity). FIG. 5D shows a block of smaller containers (the filler is not shown for clarity), which may replace the container shown in FIG. 5C. FIG. 5E shows a bundle of rod containers, which may replace box-type containers. FIG. 5F shows a container with internal cooling channels (the filler is not shown for clarity), which may replace groups of containers with external cooling.

### EMBODIMENT OF THE INVENTION

The description of a possible, but not the only, option of the claimed invention is given below.

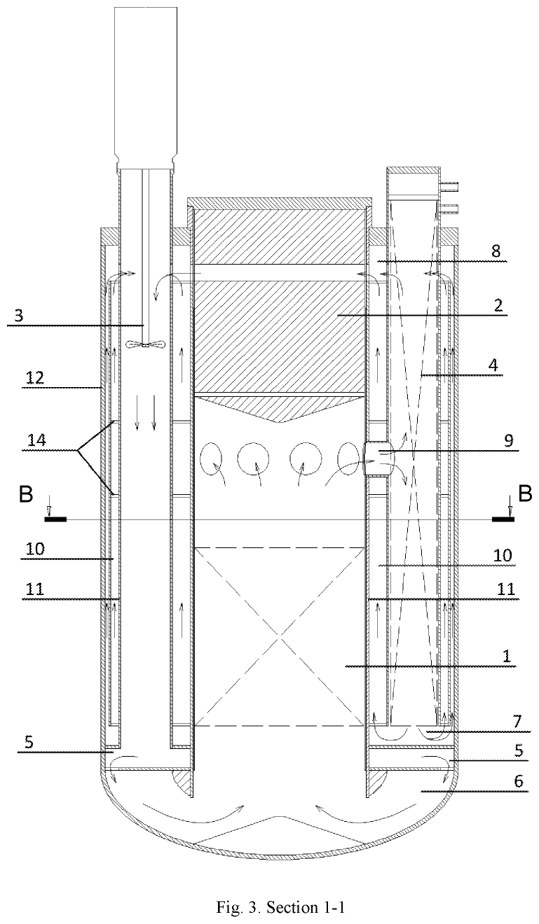

The reactor unit vessel (FIG. 3) includes a core 1 with a plug 2, a circulation pump 3, a heat exchanger 4, a pressure chamber 5, main channels 6, a lower chamber 7, an upper chamber 8, connecting pipes 9, and containers 10.

A heavy liquid metal coolant based on lead or lead-bismuth alloys is used as the coolant.

The containers 10 are located both in the low-temperature part of the primary circuit of the reactor and in the high-temperature part of the circuit.

The containers 10 are made of HLMC corrosion-resistant, high-temperature and heat-resistant austenitic steels.

The containers 10 fill the entire in-vessel space, except for the lowering channel of the pump 3 and the headers above and below the core 1. The containers 10 together with the shell 11 around the core 1 with the plug 2, the shell of the vessel 12, the radial ribs 13, and the annular horizontal ribs 14 form the load-bearing structure of the vessel. Holes for the coolant passage in the vertical direction are arranged in the annular horizontal ribs 14. The hole shape is selected so as to ensure the convenience of welding the load-bearing structure, the mounting of the blocks, and the uniform distribution of the coolant from the headers to the inlet of the vertically oriented slots. The holes can be of a cylindrical shape.

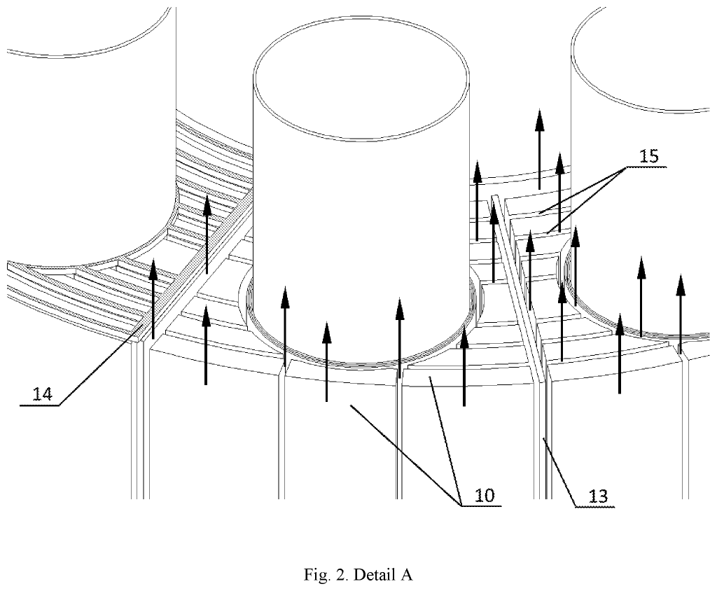

The dimensions of the gaps 15 (FIG. 2) between the containers 10 and the elements of the load-bearing structure are selected in such a way that, at a coolant flow rate corresponding to the nominal power level of the nuclear reactor, the flow is turbulent.

When choosing a specific design of the containers, including their volume, density, and filler material (steel or boron carbide in the form of denser hot-pressed blocks or less dense powder filling), the following factors are taken into account:
The temperatures do not increase above the level, at which the compatibility of materials is ensured;
The temperature of the block materials does not increase above the temperature of the coolant outlet from the core;
The volume and weight of the block materials are sufficient to perform the radiation protection function for the vessel and the equipment located in it, as well as the secondary circuit coolant;
The cross-sectional area for the coolant passage and the wetted perimeter of the blocks and elements of the load-bearing structure will be such that the turbulent flow of the coolant in the in-vessel space is ensured at a coolant flow rate corresponding to the nominal power output level of the nuclear reactor.

The fulfillment of the above mentioned criteria is verified by appropriate calculations made using known calculation methods.

A significant increase in speed in the gaps between the blocks above the turbulence limit is undesirable, since it results in an increase in the hydraulic resistance. A significant increase in the gap size with a decrease in the velocity and the transition to a laminar flow is also undesirable, since it impairs the heat transfer between the coolant and the containers.

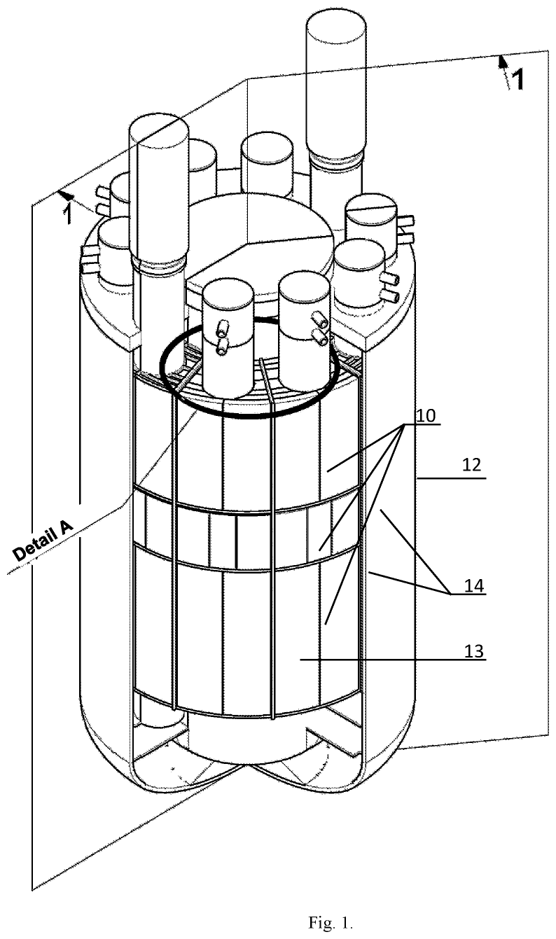

During normal operation, the cold coolant is fed by the circulation pump 3 into the pressure chamber 5, from where it enters the inlet of the core 1 through channels 6. In the core 1, the coolant is heated and enters the volume above the core 1, and then enters the connecting pipes 9, which ensure the supply of the hot coolant to the steam generators or heat exchangers of the second circuit (the heat exchanger pipe system is not shown for clarity). FIG. 1 and FIG. 2 show that there can be several such heat exchangers with their corresponding connecting pipes. After entering the heat exchangers 4, the coolant is divided into two flows. Part of the coolant moving upwards is cooled by the secondary circuit coolant and enters the upper chamber 8. The part of the coolant moving downwards is also cooled by the secondary circuit coolant and enters the lower chamber 7, where it turns in the upward direction. When moving upwards, most of the coolant moves in the in-vessel space between the blocks 10 and eventually also enters the upper chamber 8. An insignificant part of the coolant from the lower chamber 7 enters into the gap between the vessel 12 and the shell 11 (see FIG. 3) to ensure temperature control of the reactor vessel. The ratio of the upward and downward flow rates of the heat exchanger is selected by calculation, so that the temperatures of the primary circuit coolant at the outlet of the two coolant flows from the heat exchanger 4 are approximately equal, taking into account their heating in the channels between the containers 10 and in the vessel temperature control channel.

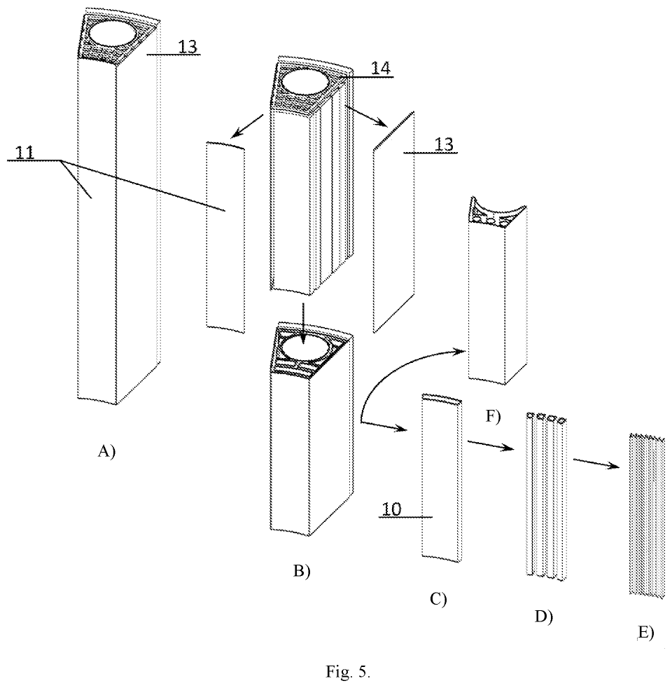

The design of containers 10, based on the need to simultaneously achieve the key technical results, namely, forming the required composition of radiation protection, increasing the heat storage capacity of the primary circuit of the reactor unit, ensuring the required heat transfer to the elements performing the functions of a heat accumulator, and reducing the weight of the reactor unit, can vary as shown in FIG. 5.

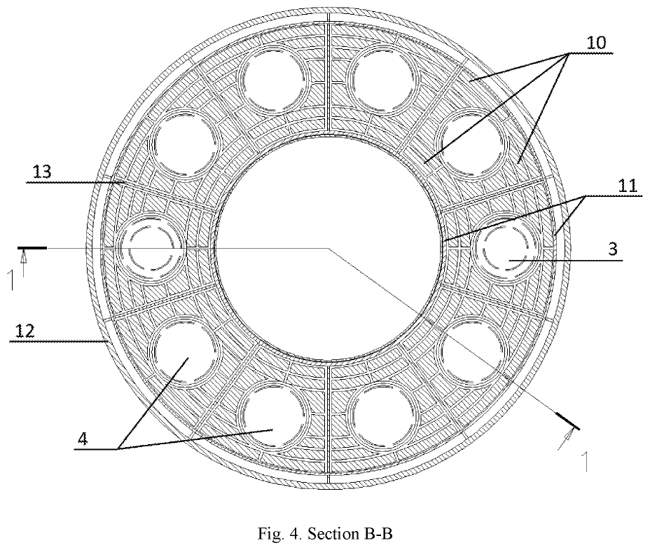

Not only boron carbide can be used as a filler for the blocks, but other materials can also be used, if necessary. For example, known materials based on hydrides of refractory metals can be used instead of boron carbide to improve the neutron moderation in local areas. To improve the gamma radiation protection or increase the heat capacity, the container filler made of steel can be used, or a thin-walled container can be replaced with a solid steel block of the respective geometry. To improve the heat transfer between the coolant and the container, as well as taking into account the ease of installation or the technology of manufacturing containers of complex geometric shape, the containers can be enlarged with the formation of internal channels, as shown in the embodiments in FIG. 4.

The free volume of the containers 10 can communicate with the coolant volume through specially arranged plugs, in which a filter made, for example, of a metal wire, is installed, which prevents the ingress of boron carbide into the primary circuit. At the same time, the heat transfer between the coolant and the container materials is improved.

The described arrangement of the containers 10 inside the reactor vessel forms a coolant path through which the coolant passes when moving upwards from the lower chamber 7 to the upper chamber 8.

In the event of any type of accident resulting in deterioration of the heat removal from the core, a significant volume of blocks made of material with a heat capacity greater than that of the coolant performs the function of a heat accumulator. At the same time, the heat capacity of the blocks is higher than the heat capacity of the coolant displaced by them, which, in combination with the developed surface of the containers, slows down the temperature increase at the core inlet and contributes to an increase in safety. The vertical channels formed between the blocks and oriented in the direction corresponding to natural convection contribute to its rapid development in case of accidents with the shutdown of circulation pumps, which also contributes to an increase in safety.

### INDUSTRIAL APPLICABILITY

The technical solution according to the invention can be used in power plants that use a reactor with a heavy liquid metal coolant (HLMC) based on lead or based on lead-bismuth alloys. The proposed nuclear reactor design provides a high degree of safety.

1. A nuclear reactor with a heavy liquid metal coolant, with, located in the same vessel, at least one heat exchanger or at least one steam generator, control and monitoring elements, one circulation pump of the primary circuit, main channels and auxiliary channels, designed for the coolant flow, that do not perform the function of core cooling, including a header for collecting and distributing the coolant through the main and auxiliary channels, characterized in that in the in-vessel space of the nuclear reactor, not occupied by these elements, containers are placed with gaps, providing the coolant flow, wherein the said containers are filled with a material that reflects or absorbs neutrons, with a heat capacity greater than that of the coolant, wherein the said containers are placed in such a way that the resulting gaps form channels with a turbulent coolant flow for cooling these containers at its flow rate corresponding to the nominal power level of the nuclear reactor.

2. The nuclear reactor according to claim 1, characterized in that the containers are placed in such a way that the channels for the coolant flow formed between them are located preferably vertically.

3. The nuclear reactor according to claim 1, characterized in that boron carbide is used as a container filler.

4. The nuclear reactor according to claim 3, characterized in that the boron carbide in the containers is in the form of a vibro-compacted powder.

5. The nuclear reactor according to claim 3, characterized in that the boron carbide in the containers is in the form of hot-pressed blocks.

6. The nuclear reactor according to claim 3, characterized in that the boron carbide in one part of the containers is in the form of hot-pressed blocks, and in the other part it is in the form of a vibro-compacted powder.

7. The nuclear reactor according to claim 3, characterized in that materials based on hydrides of refractory metals are used as a filler in some of the containers.

8. The nuclear reactor according to claim 3, characterized in that steel is used as a filler in some of the containers.

9. The nuclear reactor according to claim 3, characterized in that inside the containers there is a free volume not filled by the filler.

10. The nuclear reactor according to claim 3, characterized in that the containers are equipped with plugs in which a filter is placed.

11. The nuclear reactor according to claim 10, characterized in that the plugs are made of a metal wire.

12. The nuclear reactor according to claim 1, characterized in that instead of containers, solid steel blocks are used while maintaining the external dimensions of the containers.

13. The nuclear reactor according to claim 1, characterized in that the containers are made in the form of bundles of rod containers.

14. The nuclear reactor according to claim 1, characterized in that the containers include internal cooling channels.
